(19) United States
(12) Patent Application Publication
(10) Pub. No.: US 2023/0278733 A1
(43) Pub. Date: Sep. 7, 2023

(54) Propulsion System for an In-situ Acoustic Wildfire Suppression Unmanned Vehicle

(71) Applicant: Incaendium Initiative Corporation, Richmond, VT (US)

(72) Inventors: Geoffrey Adam Bruder, Rocky River, OH (US); Michael Steven Thomas, Richmond, VT (US)

(21) Appl. No.: 18/118,480

(22) Filed: Mar. 7, 2023

Related U.S. Application Data
(60) Provisional application No. 63/317,378, filed on Mar. 7, 2022.

(51) Int. Cl. B64U 50/13; B64U 50/18; B64C 15/02; B64C 3/10; B64U 20/80; B64U 20/60; B64D 45/00; F03H 1/00

(52) U.S. Cl. CPC B64U 50/13; B64U 50/18; B64C 15/02; B64C 3/10; B64U 20/80; B64U 20/60; B64D 45/00; F03H 1/0062; B64D 2045/009

(57) ABSTRACT

A propulsion system for an aerial vehicle having a wing structure operating in a wildfire environment, wherein the wing structure includes a drive extending through a top and a bottom surface of the wing structure and configured to provide a thrust through the top and bottom surface of the wing structure along a vertical axis of the aerial vehicle. The drive may be magnetohydrodynamic drive or an open Nacelle Fan assembly. The drive may be magnetohydrodynamic drive or an open Nacelle Fan assembly The Open Nacelle Propulsion Fan uses a drive mechanism with an induced magnetic field generated by an induction coil housed within the fan assembly open to the ambient environment, a counter-rotating fan assembly including a first fan rotating clockwise, and configured to adjust the pitch of the propulsion fan, thereby enabling the aerial vehicle's thrust to be vectored as determined by the command module.

### REFERENCE TO RELATED APPLICATIONS

This application claims priority to the U.S. provisional application No. 63/317,378 filed on Mar. 7, 2022.

### BACKGROUND OF THE INVENTION

Among the challenges of operating a vehicle within an extreme heat environment, for an extended period of time, and for repeated deployments is the ability to protect the vehicle and its components from such thermal conditions.

Other challenges include the ability to reduce or eliminate the use of a flammable or potentially explosive fuel source, or a large battery array, while extending the vehicle's time and range of operation, and using the environment as a fuel and propulsion resource.

Operations of an aerial vehicle within an evolved (wildland) fire environment requires the ability to counter multiple wind patterns.

The current invention will address such challenges.

### SUMMARY OF THE INVENTION

Described herein is a set of novel propulsion techniques for a Fire Suppression System integrated into an unmanned vehicle, either autonomous or remotely operated. The unmanned vehicle may be ground based, aerial, or aquatic. These specialized propulsion mechanisms can function within the high temperatures of an active fire, be it a wildfire or an enflamed building.

The first object of this invention is to provide a propulsion mechanism for an unmanned ground vehicle that can withstand the environment within a fire. Wheels or tracks are described that utilize high temperature materials such as ceramic, nickel-based superalloys, or cermets and use specialized bearing systems to avoid lubricants.

A second object of this invention is to provide a propulsion mechanism that will provide lift, thrust, and improved maneuverability for operations near to and within a fire environment. High temperature material fans, a novel Magnetohydrodynamic (MHD) propulsion mechanism, and a thrust vectoring system are described.

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates.

### BRIEF DESCRIPTION OF DRAWINGS

FIG. 1 is an aircraft with magnetohydrodynamic propulsion;

FIG. 2 is a rear view of the embodiment of FIG. 1;

FIG. 3 shows a top view of a delta wing including MHD ports with induction coils;

FIG. 4 illustrates an MHD port with induction coils of the embodiment of FIG. 3;

FIG. 5 depicts a propulsion fan;

FIG. 6 shows a propulsion fan assembly;

FIG. 7 depicts a propulsion fan within a nacelle;

FIG. 8 shows a propulsion fan with induction coils;

FIG. 9 illustrates an aerial vehicle with multiple magnetohydrodynamic propulsion and electric open fan propulsion subsystems;

FIG. 10 depicts a vehicle with a track system;

FIG. 11 diagrammatically depicts a track system for a ground-based unmanned vehicle carrying a fire suppression system; and

FIG. 12 diagrammatically illustrates a wheel of the track system of FIG. 11.

### DETAILED DESCRIPTION OF THE INVENTION

Hereinafter, the present invention will be described in detailed embodiments with reference to the drawings. The embodiments illustrate this invention but are not intended to limit the scope of this invention.

The Command Module in this invention is linked to the Urban Traffic Management systems, Beyond Visual Line of Sight systems, microwave systems, infrared, near-red, LIDAR, GPS, Altimeter, communication systems, gyroscope, collision detection/situational awareness sensors, pressure sensors, geofencing sensors, air pressure relief system, structural integrity monitor devices, air intake, compressor and air flow monitors and control mechanisms, air flow monitor of the convergent divergent nozzle system, flame detection, thermal detection, collision detection and avoidance, internal and external environment temperature monitors, electrical generation and distribution, battery usage and charging, filtration, propulsion systems, microelectricalmechanical systems, thermal storage, thermal transfer, cooling systems, Radio Frequency Identification, flight controllers, accelerometers and other devices, systems, and apparatus, where data from onboard systems is utilized by the Command Module to activate and adjust each propulsion system to meet the stability demands required to operate the vehicle.

The Command Module comprises a control unit, configured to control operations of the device. For example, the control unit may comprise a computing device and/or an integrated circuit. The control unit may comprise a processor, such as a microcontroller.

Each propulsion subsystem is linked with a pressure sensor, air pressure relief system, structural integrity monitor devices, air flow monitor, and control mechanism.

Each pneumatic line of this invention is additionally fitted with an air backflow preventer. The backflow preventer and solenoid of the compressor intake lines may be fitted at or in closer proximity to where the airline is connected to the air compressor and may require a diameter that is four times to ten times greater than the airline itself to ensure laminar flow. The intake of air is required to be at a rate higher or equal to the flow rate of air that is expelled.

A protective cage, or mesh of large enough coarseness to not substantially impede airflow, where the propulsion system or a part thereof is directly exposed to the external environment can be affixed to the vehicle to prevent external or environmental debris impacting, blocking, or otherwise interfering with operation of a given propulsion subsystem.

This invention will employ thermal insulating materials to stem heat transfer from the exterior surfaces of the invention toward the more temperature-sensitive interior elements. Insulative materials and the architecture of the insulating media are employed, in concert, to control overall thermal protection in the invention. An array of sensors will assess necessary temperature controls in real-time. Strategic arrays of highly conductive materials may be integrated into the invention to preferentially direct heat toward external surfaces of the invention.

The material concepts/group comprised of this invention, though not limited to, one or more of the following: ultra-high temperature ceramics (UHTC), refractory metals/alloys, carbon fiber composites, C/SiC, SiC/SiC, coated C/C, metal matrix composites, ceramic matrix composites, ceramic matrix ablators, carbon ablators, carbon-carbon ablators, aerogels, polymer matrix composites, silicates, silicides, graphites, graphene, borides, carbides, high-enthalpy alloys, MAX alloys, stainless steels, titanium alloys, aluminum alloys, superalloys, steels, wrought alloys, cast alloys, additively manufactured alloys, and abradable materials, and low-density rock materials such as steatite and lava rock. Materials definitions will withstand up to 1650 Celsius temperatures in heavily oxidizing and carbon dusting environments; an impact resistant covering or coating that impedes/eliminates projectile damage to areas of the propulsion system exposed to the external surface of the outer vessel. Such concepts include diverting potentially damaging articles away from surfaces.

Sensors would be integrated into the protective concepts such that critical damage thresholds would be detected to prompt vehicle exit from service to avoid catastrophic loss. Protective architectures for external surfaces may include any combination of screens, pins, fins, plugs, engineered surface angles, nodules, abradable/sacrificial materials.

Utilization of heat pipes, thermosiphons, and similar art known to the heat management technical community will provide temperature controls in the component such that material property limits, both physical and mechanical, will not be exceeded.

Electrical onboard power that is necessary for invention operation is generated through the conversion of heat energy to electrical energy. The invention scavenges and/or search for and collect heat from the fire environment and converts it to electricity through Thermoelectric, Thermoacoustic, Thermophotovoltaic, fuel cells, Stirling, microwave, or other energy conversion state-of-the-art either possessed in the open literature or with the inventor. Actual type, size, number of device(s), required electrical load, how connected, controlled, and placement to the vehicle to be demonstrated where the size, configuration, and specific design of the vehicle is determined, not here. The flight control system may contain an autonomous software and software programming for controlling precise flight operations of the apparatus.

One or more Command Modules will utilize data and programmed information based on data collected from one or more sensors (e.g., infrared sensor, temperature sensor). The processing of methods and systems can be performed by software components and can be described in the general context of computer executable instructions, such as program modules, execution by one or more computers, computing devices, or other devices. The system memory further comprises computer readable media in the form of volatile memory, such as random-access memory, and/or non-volatile memory, such as read only memory, and other removable/non-removable, volatile/non-volatile computer storage media. The system memory typically contains data such as the signal selection data and/or program modules such as an operating system and the signal selection software that are immediately accessible to and/or are presently operated on by the one or more processors.

Aerial Vehicle—Magnetohydrodynamics

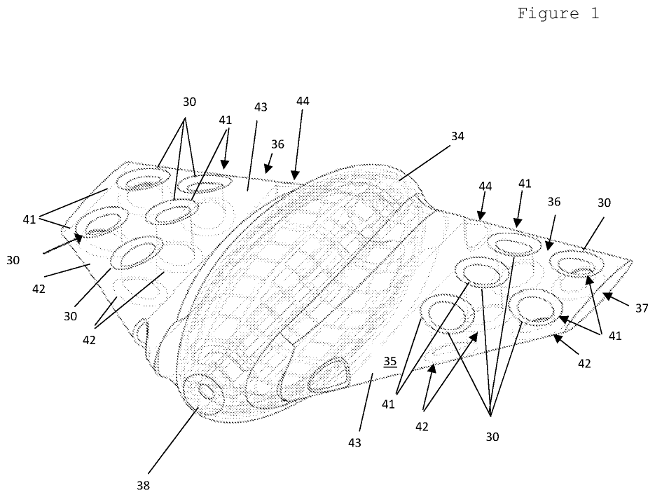

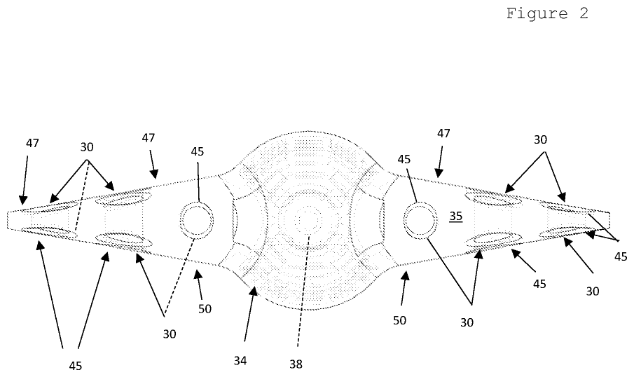

Advantageously, the present invention's aircraft propulsion system utilizes Magnetohydrodynamics (MHD) for propulsion. A magnetohydrodynamic drive is a method for propelling vehicles using only electric_ and magnetic fields_with no moving parts. In the field of magnetohydrodynamics the working fluid is the air heated to become electrically conductive. Using magnetohydrodynamics the drive mechanism is accomplished by accelerating a gas as an electrically conductive propellant. The fluid is directed to the rear and as a reaction, the vehicle accelerates forward. Air flow to the rear of the vehicle can be achieved passively, relying upon the air flow patterns generated by the fire environment. Heat tubes within the fuselage of the vehicle are configured to direct the flow of heated, ionized air, from the ambient environment to the MHD port, where in passing through the (rear of the) MHD port and interfacing with the magnetic coils of the MHD system, providing forward (vehicle movement) thrust. In an MHD drive, the solid moving rotor, is replaced by the fluid acting directly as the propellant. If the ambient working fluid is moving relatively to the magnetic field, charge separation induces an electric potential difference that can be harnessed with electrodes. In a flame, conductivity of the air atoms occurs because the temperature is high enough to cause the atoms to knock into each other and rip off electrons. FIGS. 1 and 2 show an aircraft configuration utilizing MHD propulsion. The MHD Ports (30) are designed to allow air to pass unobstructed through the top or bottom (41, 42), and/or front or rear opening of the port (30). Each MHD port (30) utilize an induction coil or series of coils housed within the heat shielding (43) of the aircraft, which produce an induced magnetic field that is controlled using an AC voltage signal from the Command Module, as the voltage is continually changing between positive and negative and it is measured in hertz.

The Navier Stokes equation of fluid dynamics and Maxwell's equation of electromagnetism describes the forces created on a fluid, wherein a magnetic field can induce currents in a moving conductive fluid. The amplitude and frequency of the supplied voltage determine the intensity and direction of the field. Advantageously, these magnetic fields utilize conductivity within the heated ambient air within the flames of the wildfire by interacting with such conductive and ionized particles and accelerate them in the form of a fluid passing through the MHD Ports (30), such conductivity in air increases with temperature, thus increases the efficacy of MHD as the environment gets hotter. The Command Module is able to use data feedback from the accelerometers mounted within the aircraft to determine which MHD Ports (30) to energize, and to what amplitude, in order to achieve the desired thrust magnitude and vector for aircraft control. To achieve the level of ionized air required by the MHD to power the aircraft, the aircraft must be proximate to or within the evolved fire environment.

Aerial Vehicle

FIG. 1 shows an embodiment of the aerial vehicle (35) having a Delta wing. FIG. 1 is a top side, lateral view, where the MHD ports (30) start at the top side of the wing (36), pass through wing (36) structure itself, exiting at the underside (not shown) of the wing (36). The wing structure/body of the aerial vehicle (35) is constructed of extreme heat resistant material (43) thereby thermally protecting the aerial vehicle (35) and components contained within same. The MHD induction coils surround the exterior of the MHD port (30) that interfaces with the thermally protected area of the wing (43). The sound wave fire suppression device (34) is positioned interior to the aerial vehicle (35), from which fire-suppression sound waves are projected (38) toward the fire environment.

FIG. 1 shows an embodiment of the aerial vehicle (35), as a Delta wing. FIG. 1 is an isometric view showing the MHD ports (30) extending from the top side of the wing (36), passing through wing (37) structure itself, and exiting at the underside of the wing (36). The wing (37) of the aerial vehicle (35) is constructed of fire and heat resistant material (43) thereby thermally protecting the aerial vehicle (35) and components contained within same from the fire environment. The MHD induction coils surround the exterior of the MHD port (30) and interfaces with the thermally protected area of the wing (42) by connecting to the protected area of the wing.

In another embodiment of FIG. 1, FIG. 2 demonstrates a top view of the aerial (35). For illustrative purposes the rear (52) of the MHD port (30) where ionized gas enters, pushing the aircraft in the opposite direction. A change in electric polarity of the induction coil in the MHD causes a change in orientation of which port of the MHD, thereby reversing the flow of the ionized gas and thrust of the MHD (30).

FIG. 2 further demonstrates a front view of MHD ports (45), passing through one side of the wing structure (50), thereafter exiting the wing at the opposite side (47).

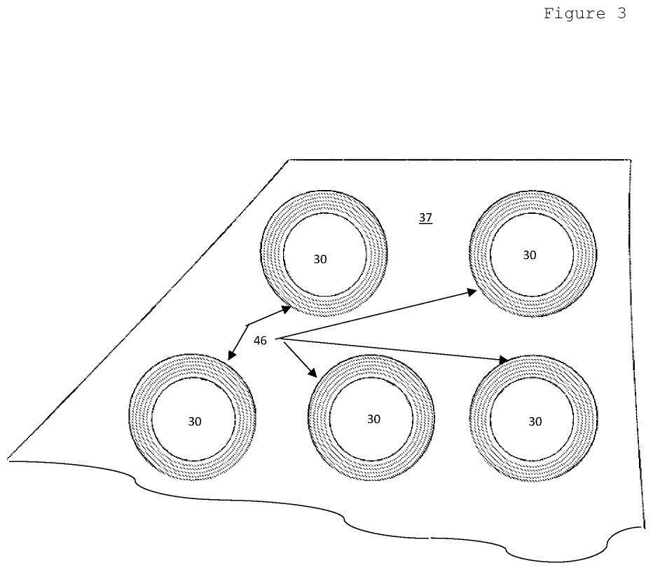

FIG. 3 shows another embodiment from a top perspective view of the wing where the MHD (30) with multiple induction coils (46) encircling the exterior wall of the MHD port (30), and as such housed within the heat shielding of the aerial vehicle (35).

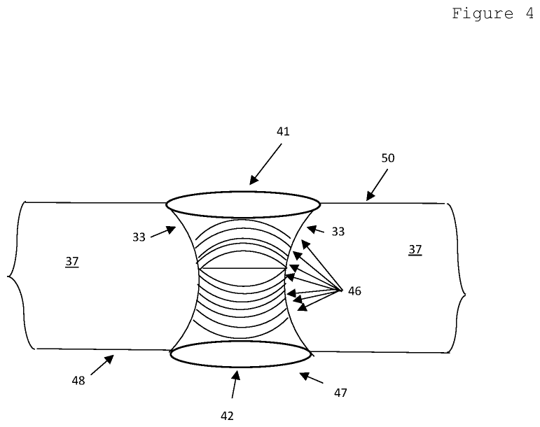

FIG. 4 depicts the MHD ports (30) separate and apart from the vehicle, here, for illustrative purposes only. Here, the induction coils (46) encircle the exterior perimeter (33) of the port. To shield the MHD induction coils (46) the induction coils are housed within the heat shielded (43) wing structure of the vehicle.

In another embodiment of FIG. 3, FIG. 4 demonstrates a frontal, lateral view of a MHD port (30) passing through a cross section of the wing (37). The induction coils (46) that encircle the MHD port (30). The induction coils (46) are housed within the heat resistant shielding of the wing (37) thereby providing protecting from the extreme heat conditions of the external environment, as ionized air passes through the rear of the MHD port (30).

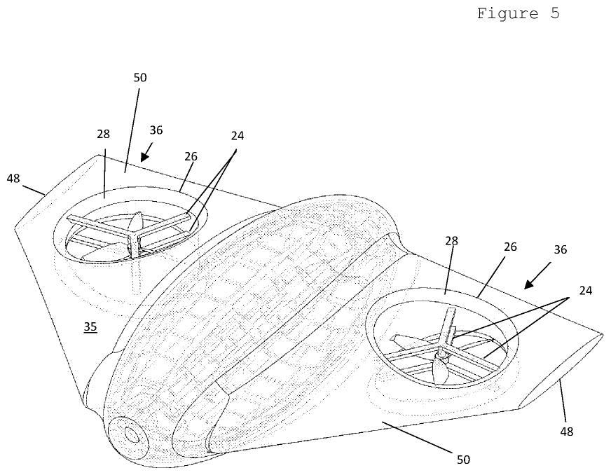

FIG. 5 illustrates a Propulsion Fan (24) system in the wing (36) of the Delta Wing aircraft (35), where the Open Nacelle Propulsion Fan assembly (24, 26, 28) begins at the anterior section (50) of the wing (36), passing through the body of the wing (37), to where it ends at the surface of but remains a part of the underside or posterior section (48) of the wing (37).

An aerial vehicle utilizing a propulsion system that uses open fan type thrusters are shown in FIGS. 5, 6, 7 and 8. Propulsion Fans are typically utilized in Vertical Takeoff and Landing (VTOL) vehicles to provide lift, allow with roll, pitch, and yaw by spinning at varied speeds around the vehicle. The Propulsion Fans (24) are mounted within radial nacelles which allow for adjustment of Open nacelle propulsion fan system (26) pitch, thereby enabling the vehicle's thrust to be vectored as necessary according to the logic within the Command Module (not shown).

In FIG. 5, the Propulsion Fans (24) are made of high temperature materials, such as Ultra High Temperature Ceramics, refractory metals with an environmentally protective coating, Ni-based superalloys, or ceramics. The Propulsion Fans (24) are open to the external environment to allow debris to freely pass through without becoming trapped within the aircraft. The bearing system for the Propulsion Fans (24) is made from ceramic materials that are highly polished to avoid the need for lubrication or can be magnetic. Magnetic Propulsion Fan bearings (27) are a high temperature permanent magnet such as Samarium-Cobalt or are electromagnets that are powered by the Command Module.

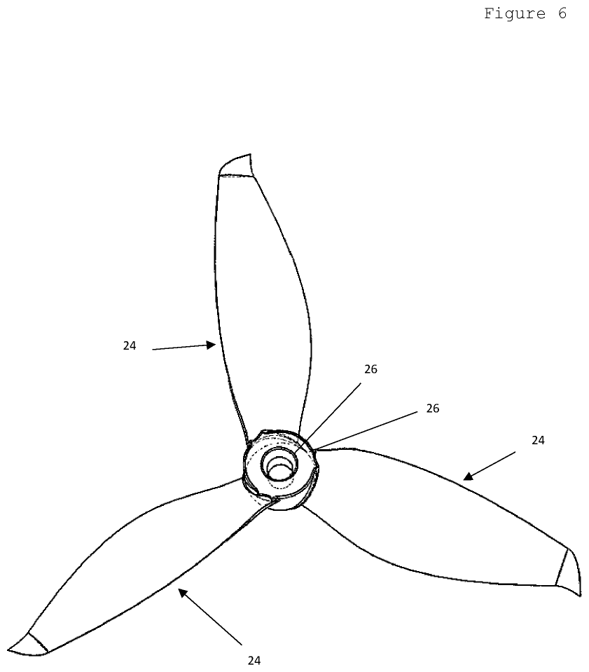

In another embodiment of FIG. 5, FIG. 6 illustrates the Magnetic Propulsion Fan bearing system (26) for the Propulsion Fans (24) is made from ceramic materials that are highly polished to avoid the need for lubrication or can be magnetic. Magnetic Propulsion Fan bearings (27) are a high temperature permanent magnet such as Samarium-Cobalt or are electromagnets that are powered by the Command Module.

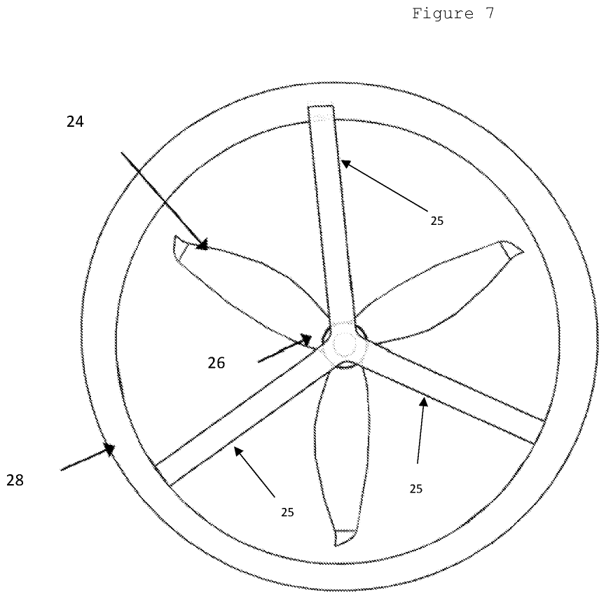

FIG. 7 depicts the Open nacelle propulsion fan system (24, 26) within the open radial nacelle (28) of the embodiment of FIG. 5. The Open nacelle propulsion fan system (24, 26) is attached to the open radial nacelle (28) by a central shaft (25). The central shaft (25) may be constructed of a material such as Ultra High Temperature Ceramics, refractory metals with an environmentally protective coating, Ni-based superalloys, cermets, or ceramics.

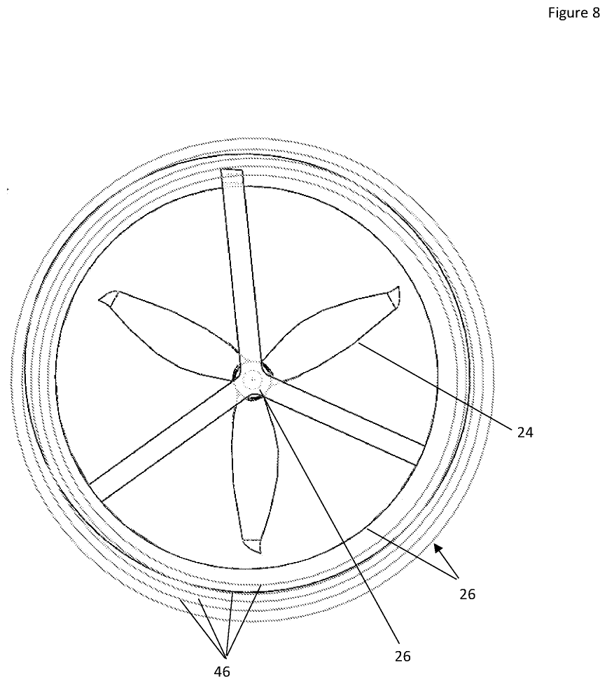

FIG. 8 depicts another embodiment of the induction coils (54) of the Open nacelle propulsion fan system (24, 26) within the open radial nacelle (28) of the embodiment of FIG. 7.

(2) Aerial Vehicle—Delta Wing with an Open Nacelle Propulsion Fan

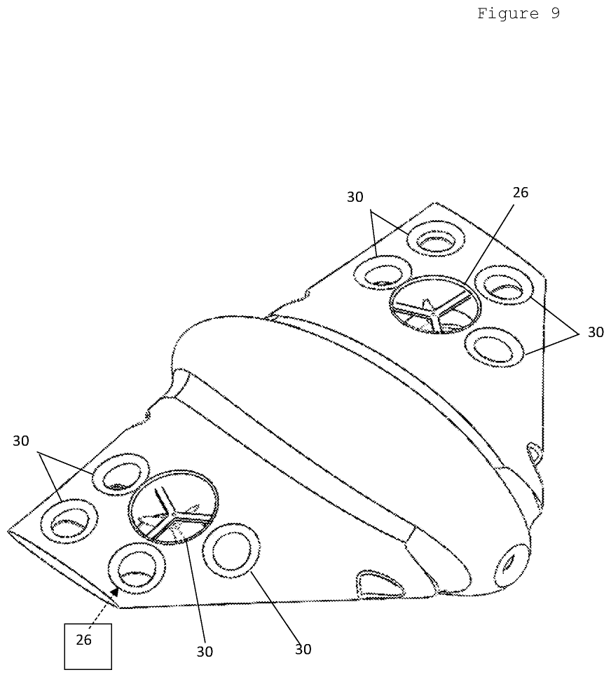

In another embodiment, FIG. 9 illustrates an aerial vehicle with multiple, independent, Command Module controlled propulsion subsystems which combine the MHD (30) and the open nacelle propulsion fan system (26). In an environment where the ion concentration within a wildfire environment is insufficient to support use of the MHD by itself, the open nacelle propulsion fan provides propulsion as required. In the various scenarios where ion concentration at the point of takeoff, within the fire environment, or upon exit from the fire environment is insufficient to support operation of the MHD for lift and/or thrust purposes, the Command Module may activate the open nacelle propulsion fan system to provide lift and thrust in order to augment MHD system operations.

The Command Module's programming algorithm, utilizing data from one or more onboard air particle counter (not shown) mounted to or within the wing assembly, and optionally proximate to the MHD port openings to measure ion concentration flow to and through the MHD, ion concentration of the air space within a predetermined area of displacement surrounding the aircraft, and may be further linked to an onboard spectrographic device (not shown) to measure the ion concentration, along with thermal, accelerometer, air pressure, particulate matter density, humidity and other flight control systems, will determine the point of sufficiency of ion concentration necessary to operate the MHD system, activate the MHD system, and further determine whether to operate the open nacelle fan propulsion system in conjunction with the MHD, or the open nacelle fan propulsion system by itself. The Command Module will further determine the operating speed and pitch of the open nacelle fan propulsion system.

Track Vehicle

To operate a manned or unmanned ground-based vehicle within an active fire situation to deliver a fire suppression system therein, and perform within an extreme high temperature environment for an extended period of time, it is necessary to equip the vehicle, its components, and its drive system from the thermal impact of such heat conditions.

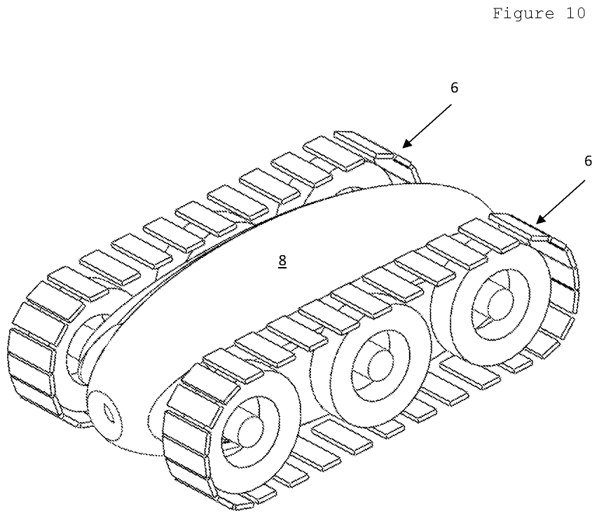

In one embodiment, FIG. 10, an is a perspective view unmanned ground-based vehicle (8), configured to utilize a track system (6), that is an extreme heat resistant or shielded track system.

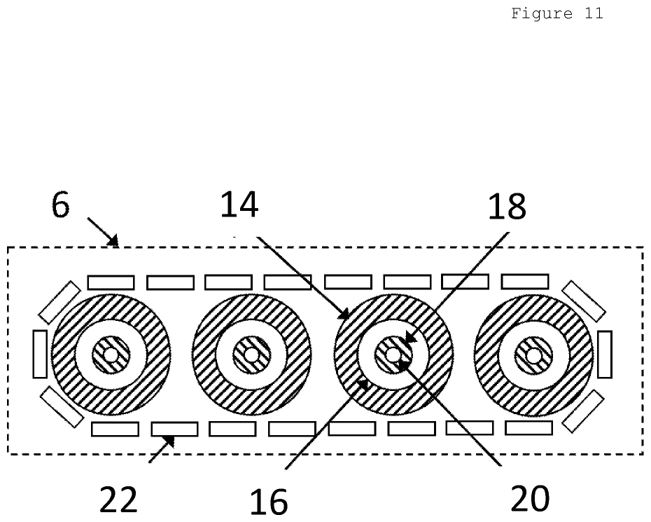

As further noted within this embodiment, FIG. 11, the track system (6) consists of track plates (22) and its components therein: track gears (14), track gear bearings (18), the internal channel (16) connected to and housing the track gears (14), and the center shaft (20), constructed for protection from extreme heat conditions over an extended period of time. This track system will be in direct contact with the ground and potentially other surfaces and materials contiguous to and within the fire environment. The drive mechanism utilizes electrical or magnetic drive motors are housed within the vehicle where they are protected from temperature and the environment and will interact as necessary with the environmentally protected components described hereafter.

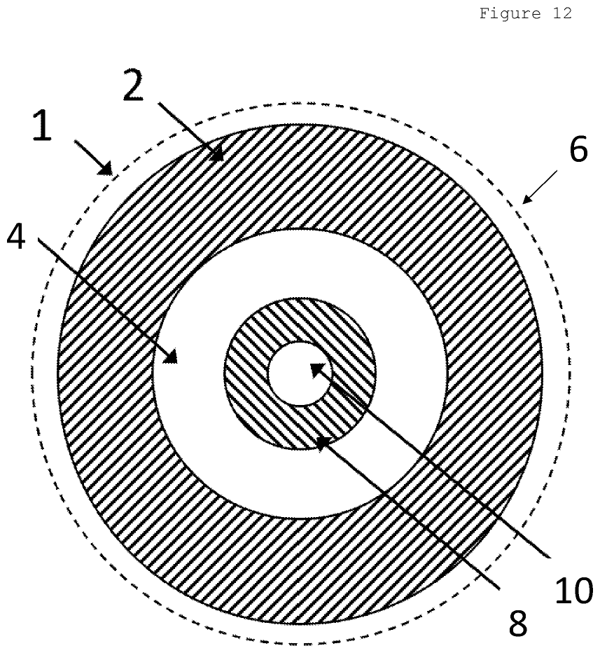

In the embodiments of FIGS. 10, 11 and FIG. 12 the track system (6) will operate within the fire environment. Track Plates (22) of FIG. 12 will be in direct contact with the ground and be constructed high temperature material such as Ultra High Temperature Ceramics, refractory metals with an environmentally protective coating, Ni-based superalloys, cermets, or ceramics. Alternatively, the Track Plates (22) may be replaced by a continuous strip, or weave, of a carbon fiber or other high temperature flexible material. The Track Plates (22) will be driven by a set of Track Gears (14). The Track Gears (14) will be made from a material that can itself survive within an active wildfire environment. Such materials include Ultra High Temperature Ceramics, refractory metals with an environmentally protective coating, Ni-based superalloys, cermets, or ceramics. An internal channel (16) may be included that enables circulation of a coolant or storage of a phase change material; these features enable the wheel to operate at a reduced temperature for a longer period. Moving inward, a high temperature bearing (18) may be constructed of a material such as Ultra High Temperature Ceramics, refractory metals with an environmentally protective coating, Ni-based superalloys, cermets, or ceramics. This bearing (18) may also be a high-temperature magnetic material such as Samarium Cobalt. The center shaft (20) will be constructed of a high temperature material such as Ultra High Temperature Ceramics, refractory metals with an environmentally protective coating, Ni-based superalloys, cermets, or ceramics. The center shaft (20) may also be a high temperature magnetic material such as Samarium Cobalt. In another object of this invention, the center shaft (20)) is hollow and enables coolant to be circulated into the internal channel (16).

The embodiment of the ground-based system would utilize a high temperature wheel (2), shown in FIG. 12, made from a material that can itself survive within an active wildfire environment. Such materials include Ultra High Temperature Ceramics, refractory metals with an environmentally protective coating, Ni-based superalloys, cermets, or ceramics. An internal channel (4) may be included that enables circulation of a coolant or storage of a phase change material; these features enable the wheel to operate at a reduced temperature for a longer period. Moving inward, a high temperature bearing (18) may be constructed of a material such as Ultra High Temperature Ceramics, refractory metals with an environmentally protective coating, Ni-based superalloys, cermets, or ceramics. This bearing (18) may also be a high-temperature magnetic material such as Samarium Cobalt. The center shaft (20) will be constructed of a high temperature material such as Ultra High Temperature Ceramics, refractory metals with an environmentally protective coating, Ni-based superalloys, cermets, or ceramics. The center shaft (20) may also be a high temperature magnetic material such as Samarium Cobalt. In another object of this invention, the center shaft (20) is hollow and enables coolant to be circulated into the internal channel (16).

It will be apparent to those skilled in the art that various modifications and variations can be made without departing from the scope or spirit of the invention. Other embodiments will be apparent to those skilled in the art from consideration of the specifications and practice disclosed herein. It is intended that the specification and examples be considered as exemplary only, with a true scope and spirit being indicated by the following claims.

COMPONENT LIST OF THE INVENTION

| | |
|---|---|
| Ground-based system utilizing a high temperature wheel | 2 |
| Internal channel | 4 |
| Ground based vehicle track system | 6 |
| Ground based vehicle | 8 |
| Track Gears | 14 |
| Internal channel | 16 |
| High temperature bearing | 18 |
| Center shaft | 20 |
| Track Plates | 22 |
| Propulsion Fans | 24 |
| Central shaft | 25 |
| Open nacelle propulsion fan system | 26 |
| Magnetic Propulsion Fan bearing | 27 |
| Radial nacelles | 28 |
| MHD Ports | 30 |
| MHD port perimeter | 33 |
| Sound wave fire suppression device | 34 |
| Aerial vehicle | 35 |
| Aircraft wing | 36 |
| Wing structure | 37 |
| Area of the vehicle from which the suppression sound | 38 |
| wave is projected | |
| MHD Port top | 41 |
| MHD Port bottom | 42 |
| Heat resistant | 43 |
| Air exit port | 44 |
| Through wing placement of MHD ports | 45 |
| Induction coils | 46 |
| Opposite side of the wing | 47 |
| Posterior section of the wing structure | 48 |
| Anterior section of the wing | 50 |
| Rear view of the vehicle | 52 |

1. A propulsion system for an aerial vehicle having a wing structure operating in a wildfire environment, comprising: the wing structure including a drive extending through a top and a bottom surface of the wing structure and configured to provide a thrust through the top and bottom surface of the wing structure along a vertical axis of the aerial vehicle.

2. The propulsion system of claim 1, wherein the drive is a magnetohydrodynamic drive (MHD) having an induction coil, the MHD extending through the wing structure and having an inlet and an outlet, the MHD being configured to receive and accelerate ambient ionized air through the MHD to thereby create a thrust by the interaction between the ambient ionized air and the induction coil.

3. The propulsion system of claim 1, wherein the drive is an Open Nacelle Propulsion Fan Assembly including a propulsion fan.

4. The propulsion system of claim 3, wherein the Open Nacelle Propulsion Fan Assembly includes a propeller.

5. The propulsion system of claim 2, further comprising a command module operatively connected to the drive for controlling the MHD.

6. The propulsion system of claim 3, further comprising a command module operatively connected to the drive for controlling the Open Nacelle Propulsion Fan Assembly.

7. The propulsion system of claim 6, further comprising an open fan type thruster mounted within the Open Nacelle Fan Assembly and configured to adjust the pitch of the propulsion fan, thereby enabling the aerial vehicle's thrust to be vectored as determined by the command module.

8. The propulsion system of claim 6, further comprising an open fan subsystem open to the ambient environment to allow debris to freely pass through without becoming trapped therein.

9. The propulsion system of claim 6, further comprising a primary drive mechanism using an induced magnetic field generated by an induction coil housed within the Open Nacelle Propulsion Fan Assembly.

10. The propulsion system of claim 8, further comprising a counter-rotating fan assembly including a first fan rotating clockwise and a second fan rotating counterclockwise such that the angular momentum of the first fan is offset by the second fan.

11. The propulsion system of claim 9 further comprising:
a. A bearing system for the propulsion fan is made from ceramic materials that are highly polished to avoid the need for lubrication; and
b. A magnetic bearing system for the propulsion fan made from a high temperature magnetic material such as Samarium Cobalt or electromagnets;
wherein the command module supplies an AC voltage to the induction coil which magnetically influences the rotation of the propulsion fan while the amplitude and frequency of the supplied AC voltage determines the speed of rotation of the propulsion fan.

12. The propulsion system of claim 6, further comprising accelerometers housed throughout the aerial vehicle operatively connected to the command module to detect lateral and horizontal motion induced by turbulent forces within a wildfire.

13. The propulsion system of claim 6 further comprising an MHD to achieve the desired thrust magnitude and vector for control of the aerial vehicle.

14. The propulsion system of claim 12 further comprising:
a. MHD Ports, each said MHD port having an induction coil housed within a heat shield, which produces a magnetic field controlled by an AC voltage signal from the command module; and
b. Accelerometers mounted within the aerial vehicle and operatively connected to the command module that uses data from the accelerometers to determine which MHD Ports to energize, and to what amplitude, in order to achieve the desired thrust magnitude and vector for control of the aerial vehicle.

15. The propulsion system of claim 13, wherein the wing structure is configured as a Delta Wing providing a large surface area on which the buoyant forces of the wildfire can provide lift to the aerial vehicle.

16. The propulsion system of claim 13, wherein the wing structure is constructed of a material that withstands temperatures of 1650 Celsius or greater in heavily oxidizing and carbon dusting environments, the material being made of ultra-high temperature ceramics, refractory metals/alloys, carbon fiber composites, C/SiC, SiC/SiC, coated C/C, metal matrix composites, ceramic matrix composites, ceramic matrix ablators, carbon ablators, carbon-carbon ablators, aerogels, polymer matrix composites, silicates, silicides, borides, carbides, graphites, graphene, high-enthalpy alloys, MAX alloys, stainless steels, titanium alloys, aluminum alloys, superalloys, steels, wrought alloys, cast alloys, additively manufactured alloys, and abradable materials, and low-density rock materials such as steatite and lava rock, impact resistant coverings or coatings that are resistant to projectile damage to areas of the propulsion system.

17. The propulsion system of claim 14, further comprising sensors integrated into the aerial vehicle such that critical damage thresholds would be detected to prompt vehicle exit from service to avoid catastrophic loss, with a protective architecture for external surfaces may include any combination of screens, pins, fins, plugs, engineered surface angles, nodules, and abradable/sacrificial materials.

18. The propulsion system of claim 15, further comprising one or more secondary command modules linked to accelerometers housed throughout the aircraft to detect lateral and horizontal motion induced by the turbulent forces within the wildfire and to activate the respective propulsion subsystem(s) to counteract unwanted motion in order to maintain stability, able to slow the rotation of the propulsion fans to induce the required lift, roll, pitch, or yaw for attitude adjustment of the aerial vehicle.

19. The propulsion system of claim 16, further comprising one or more tertiary command modules for processing software components, computer executable instructions, one or more system memories with computer readable media in the form of volatile memory, read only memory random-access memory, non-volatile memory, and other removable/non-removable, volatile/non-volatile computer storage media, operating systems, signal selection software, and/or program modules that are immediately accessible to and/or are operated on by one or more processors.
